(19) United States
(12) Patent Application Publication
(10) Pub. No.: US 2023/0044778 A1
(43) Pub. Date: Feb. 9, 2023

(54) METHOD FOR MANUFACTURING EXTERIOR CASE FOR HOT-WATER UNIT

(71) Applicant: NORITZ CORPORATION, HYOGO (JP)

(72) Inventor: Nobuhiro FUKUI, Hyogo (JP)

(73) Assignee: NORITZ CORPORATION, HYOGO (JP)

(21) Appl. No.: 17/786,537

(22) PCT Filed: Dec. 18, 2020
(86) PCT No.: PCT/JP2020/047461

§ 371 Date: Jun. 17, 2022

(30) Foreign Application Priority Data
Dec. 24, 2019 (JP) 2019-233415

(51) Int. Cl. B29C 64/112; B41J 2/01; F24H 9/02; B29C 64/393

(52) U.S. Cl. CPC B29C 64/112; B41J 2/01; F24H 9/02; B29C 64/393; B33Y 10/00

(57) ABSTRACT

Provided is a method for manufacturing an exterior case for a hot-water unit, used to house hot-water equipment for generating or storing hot water inside. The method includes a step combining an inkjet printing step for forming an inkjet printing layer by applying inkjet printing to the outer surface of a component of the exterior case and a curing step for curing the inkjet printing layer, in which the inkjet printing step and the curing step are repeated a plurality of times at the same location to form a thick printing portion in which the plurality of inkjet printing layers are laminated in an overlaid state.

### TECHNICAL FIELD

The invention relates to a manufacturing method for manufacturing an exterior case for a hot-water unit used to house hot-water equipment for generating or storing hot water in a hot-water unit such as a water heater or a cogeneration system.

### RELATED ART

The applicant has previously proposed the ones described in Patent Documents 1 and 2 as specific examples of the exterior case for the hot-water unit.

The exterior cases for the hot-water unit described in these documents are, for example, formed by press-working color steel sheets having a paint layer provided on the outer surface of a metal plate. An inkjet printing layer is provided on the paint layer, and characters, symbols, figures, patterns, and so on (hereinafter, abbreviated as a design as appropriate) are displayed by the inkjet printing layer.

According to this configuration, by using an inkjet printer, it is possible to efficiently, rapidly, and easily represent a desired design on the surface of the exterior case and enhance the aesthetic properties. Compared with the conventional spray painting method, it is possible to improve the operating environment and greatly improve the productivity. The effect of reducing the manufacturing cost of the hot-water unit can also be obtained.

However, in the above-mentioned prior art, the inkjet printing layer is provided only as a single layer. Therefore, although a two-dimensional design can be represented by the inkjet printing layer, it is difficult to represent more (for example, three-dimensional representation). From the viewpoint of increasing the commercial value of the exterior case, it is desired to have functionality other than the flat design representation. In addition, the single-layer inkjet printing layer is susceptible to damage, and there is a risk of chalking occurring due to aging. Chalking is a phenomenon in which the pigment in the coating film is powdered and appears on the surface of the printing layer.

### CITATION LIST

### Patent Literature

Patent Literature 1: Japanese Patent Application Laid-Open No. 2019-60508

Patent Literature 2: Japanese Patent Application Laid-Open No. 2019-60509

### SUMMARY OF INVENTION

### Technical Problem

An object of the invention is to provide a method for manufacturing an exterior case for a hot-water unit, having unpreceded functionality or aesthetic properties.

### Solution to Problem

In order to solve the above problems, the following technical means are taken in the invention.

The method for manufacturing an exterior case for a hot-water unit according to the invention is a method for manufacturing an exterior case for a hot-water unit, used to house hot-water equipment for generating hot water or storing hot water inside. The method includes a step for combining an inkjet printing step for forming an inkjet printing layer by applying inkjet printing to an outer surface of a component of the exterior case; and a curing step for curing the inkjet printing layer, in which the inkjet printing step and the curing step are repeated a plurality of times at a same location to form a thick printing portion in which a plurality of inkjet printing layers are laminated in a overlaid state.

Preferably, the exterior case includes an exterior case body having an opening portion on at least one surface, and a cover body attached to the exterior case body so as to close the opening portion, and the thick printing portion on an outer surface of at least one of the exterior case body and the cover body is formed.

Preferably, an ink containing an ultraviolet curable resin is used in the inkjet printing, and ultraviolet light irradiation is performed in the curing treatment of the inkjet printing layer.

Preferably, an ink further containing a thermosetting resin is used in the inkjet printing, and the inkjet printing layer is heated and thermally cured after the curing of the inkjet printing layer by ultraviolet light is completed.

Preferably, an outermost layer of the inkjet printing layers of the thick printing portion is a clear layer.

Preferably, the exterior case has at least one of an exhaust port and an air supply port, and the method for manufacturing an exterior case for a hot-water unit according to the invention includes a step for forming a thick printing portion provided around the exhaust port or the air supply port as the thick printing portion.

Preferably, the method for manufacturing the exterior case for the hot-water unit according to the invention includes a step for forming a thick printing portion including a plurality of opaque inkjet printing layers containing pigments, and inkjet printing layers as clear layers located in between so as to separate the plurality of inkjet printing layers from each other in a printing thickness direction as the thick printing portion.

Preferably, the method for manufacturing an exterior case for a hot-water unit according to the invention further includes a step for providing an inkjet printing layer for design representing at least one of characters, symbols, figures, or patterns on the outer surface of the component of the exterior case.

Preferably, the method for manufacturing an exterior case for a hot-water unit according to the invention includes a step for forming a thick printing portion in a form of a plurality of dots separated from each other and constituting Braille as the thick printing portion.

Other features and advantages of the invention will become more apparent from the following description of embodiments of the invention with reference to the accompanying drawings.

BRIEF DESCPRIPTION OF DRAWINGS

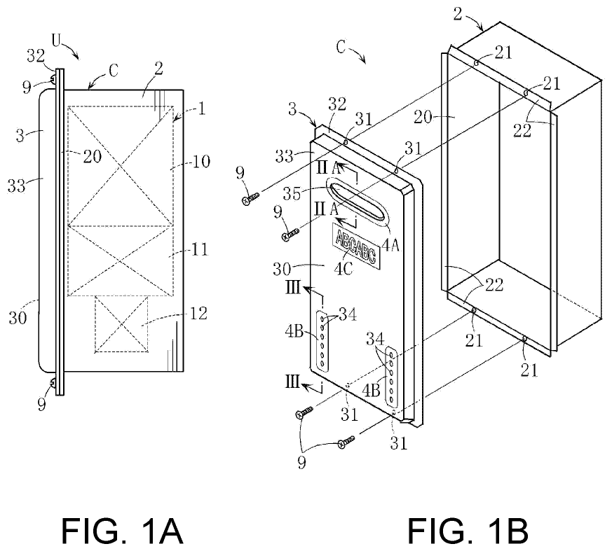

FIG. 1A is a side view showing an example of a hot-water unit equipped with an exterior case manufactured by the manufacturing method according to the invention, and FIG. 1B is an exploded perspective view of the exterior case shown in FIG. 1A.

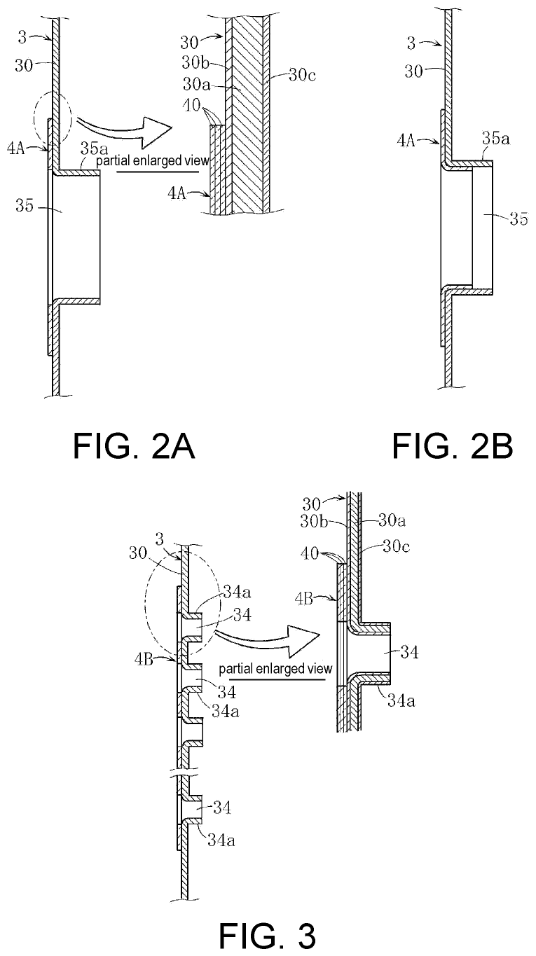

FIG. 2A is a cross-sectional view of IIA-IIA of FIG. 1B, and FIG. 2B is a cross-sectional view of main parts showing another example for the configuration shown in FIG. 2A.

FIG. 3 is a cross-sectional view taken along a line III-III of FIG. 1B.

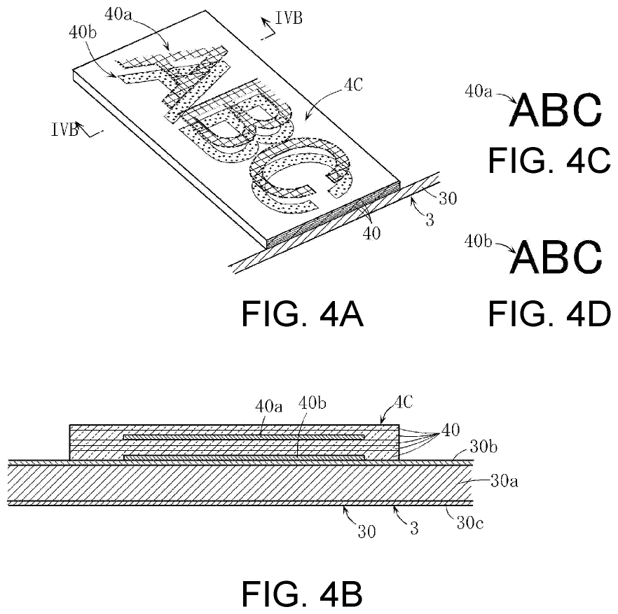

FIG. 4A is a cross-sectional perspective view of a partially broken portion of a third thick printing portion 4C shown in FIG. 1B, FIG. 4B is a sectional view taken along a line IVB-IVB of FIG. 4A, and FIGS. 4C and 4D are explanatory views of a part of the inkjet printing layers shown in FIG. 4B.

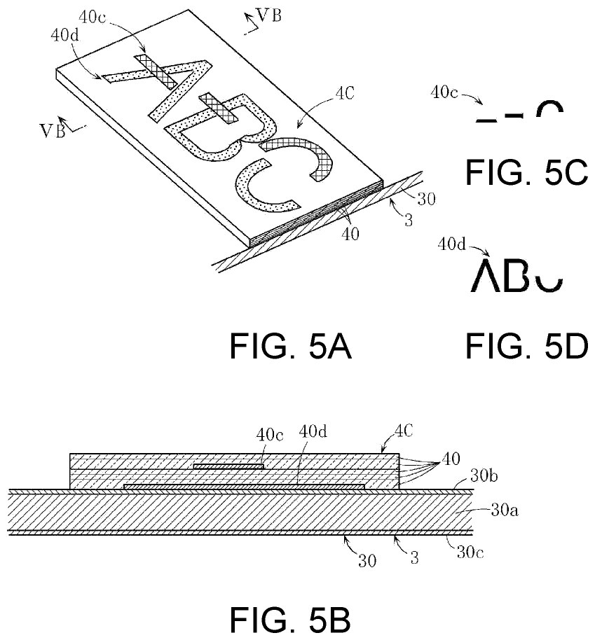

FIG. 5A is a cross-sectional perspective view of a partially broken portion showing another example of the third thick printing portion 4C shown in FIG. 1B, FIG. 5B is a cross-sectional view taken along a line VB-VB of FIG. 5A, and FIGS. 5C and 5D are explanatory views of a part of the inkjet printing layers shown in FIG. 5B.

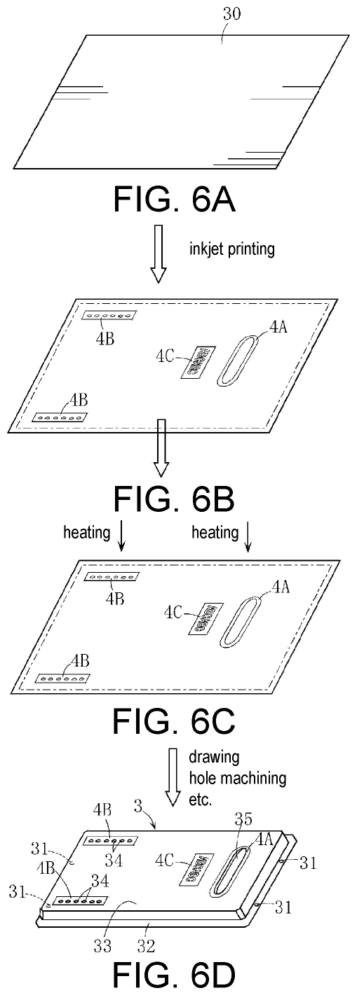

FIGS. 6A to 6D are explanatory views showing an example of the manufacturing method according to the invention, and correspond to a series of operating steps of the manufacturing method of the cover body shown in FIG. 1B.

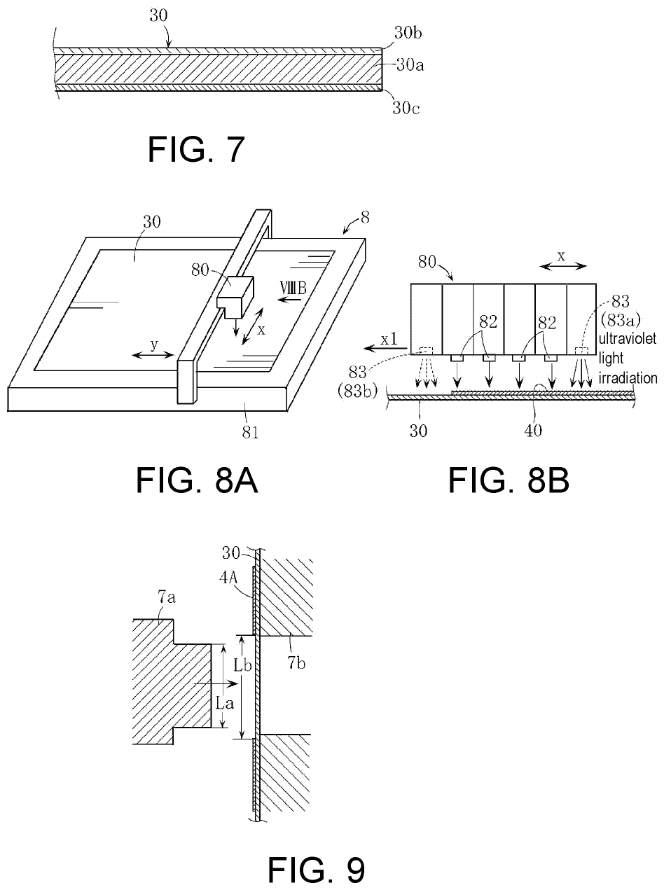

FIG. 7 is a cross-sectional view of main parts showing an example of a color steel sheet used for manufacturing the cover body shown in FIG. 1B.

FIG. 8A is a perspective view showing an example of a schematic configuration of a printer used for inkjet printing, and FIG. 8B is a figure viewing from an arrow VIIIB of FIG. 8A, showing a schematic structure of the print head of the printer shown in FIG. 8A.

FIG. 9 is a cross-sectional view of main parts showing an example of an operating step for obtaining the structure of FIG. 2A.

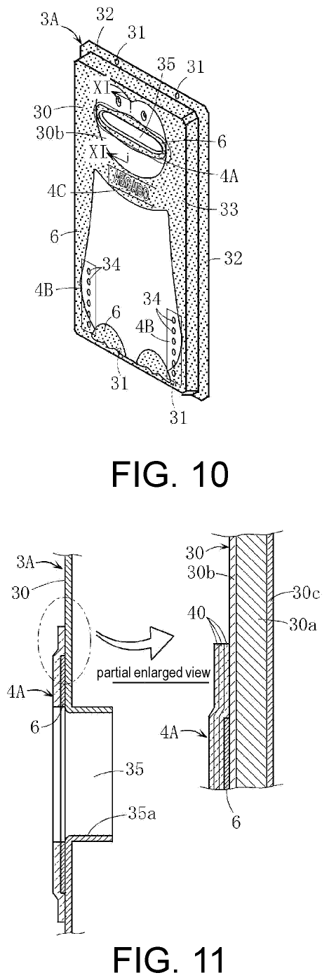

FIG. 10 is a perspective view showing another example of a cover body of an exterior case manufactured by the manufacturing method of the invention.

FIG. 11 is a cross-sectional view taken along a line XI-XI of FIG. 10.

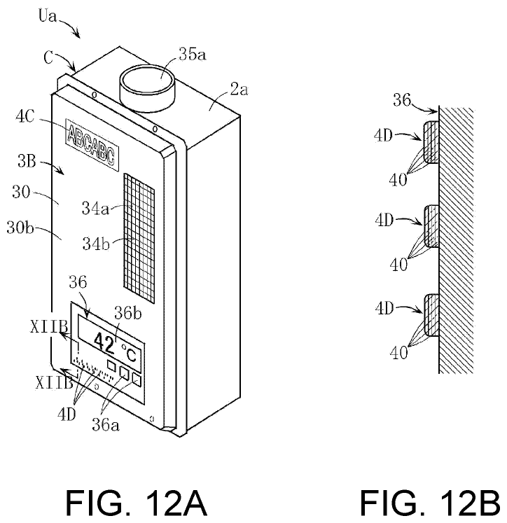

FIG. 12A is a perspective view showing another example of an exterior case manufactured by the manufacturing method of the invention, and FIG. 12B is a cross-sectional view taken along a line XIIB-XIIB of FIG. 12A.

### DESCRIPTION OF EMBODIMENTS

Hereinafter, preferred embodiments of the invention will be specifically described with reference to the drawings.

First, in order to facilitate understanding, the configuration of an exterior case C for a hot-water unit manufactured by the manufacturing method of the present embodiment and a hot-water unit U equipped with the exterior case C will be described.

In FIGS. 1A and 1B, the hot-water unit U is a water heater, and hot-water equipment 1 for generating hot water is housed in the exterior case C. The hot-water equipment 1 includes a heat exchanger 10 through which hot water flows, a burner 11 for heating the hot water in the heat exchanger 10, a fan 12 for supplying combustion air to the burner 11, and the like.

The exterior case C includes a rectangular box-shaped case body 2 having an opening portion 20 on the front surface, and a cover body 3 (front cover body) that closes the opening portion 20. The cover body 3 is detachably attached to the front surface portion of the case body 2 by using, for example, a screw body 9 such as a screw and screw insertion holes 31 and 21 through which the screw bodies 9 are is inserted.

In the present embodiment, the cover body 3 is provided with a first to a third thick printing portions 4A to 4C, which are not provided on the case body 2. Therefore, hereinafter, the configuration of the cover body 3 will be described in detail, and the description of the case body 2 will be omitted. However, as will be described later, it goes without saying that the case body 2 may be provided with the thick printing portion or the like.

The cover body 3 is formed by press-working a color steel sheet 30 to be described later, and has a panel shape having a substantially rectangular front view. The cover body 3 has an outer peripheral flange portion 32 and a bulging portion 33 that is surrounded by the outer peripheral flange portion 32 and that bulges forward (front side of the exterior case C) from the outer peripheral flange portion 32. The outer peripheral flange portion 32 is a portion for abutting on a flange portion 22 on the front surface portion of the case body 2. The bulging portion 33 is provided with a plurality of air supply ports 34 that allow outside air to flow into the exterior case

C, and an exhaust port 35 for discharging exhaust gas that has been heat-recovered by the heat exchanger 10 to the outside of the exterior case C.

As shown in FIG. 7, the color steel sheet 30 has a multi-layer structure including a plated steel sheet 30a, a white-based (including white) front-side paint layer 30b laminated on the surface of the plated steel sheet 30a as an outer surface, and a back-side paint layer 30c as a service coat laminated on the back surface of the plated steel sheet 30a as an outer surface. The paint layer 30b is located on the surface side of the cover body 3, and the first to the third thick printing portions 4A to 4C are provided on the paint layer 30b.

The first thick printing portion 4A is provided around the exhaust port 35, as well shown in FIG. 2A. The first thick printing portion 4A is a portion where a plurality of inkjet printing layers 40 are laminated in an overlaid state. These plurality of inkjet printing layers 40 are, for example, all clear layers and do not contain pigments. However, each of the inkjet printing layers 40 contains an ultraviolet curable resin and a thermosetting resin (the same applies to a second and a third thick printing portions 4B and 4C, and thick printing portions 4D to be described later).

The exhaust port 35 is formed as a burring hole in which a cylindrical burring portion 35a is continuously provided on the back surface side of the peripheral portion thereof. The first thick printing portion 4A is not provided at a position facing the exhaust port 35 so as to avoid a corner portion of the burring portion 35a. This is preferable in order to prevent damage to the first thick printing portion 4A when the exhaust port 35 is formed after the formation of the first thick printing portion 4A, as will be described later. However, the invention is not limited thereto, and may have, for example, a configuration in which the first thick printing portion 4A is extended to the formation portion of the burring portion 35a, as shown in FIG. 2B.

As is well shown in FIG. 3, the second thick printing portion 4B is provided around the plurality of air supply ports 34. Similar to the first thick printing portion 4A, the second thick printing portion 4B is a portion where the plurality of inkjet printing layers 40 are laminated in an overlaid state. The plurality of inkjet printing layers 40 are all clear layers. Similar to the exhaust port 35, each air supply port 34 is also formed as a burring hole, and the second thick printing portion 4B is provided so as to avoid a burring portion 34a.

A third thick printing portion 4C represents characters such as the manufacturer, model, or trademark of the hot-water unit U (“ABCABC” is shown as an example in the drawing). The third thick printing portion 4C is composed of the plurality of inkjet printing layers 40 that overlap each other, as is well shown in FIGS. 4A to 4D (in the same figure, only “ABC” is represented), but a plurality of (for example, two) inkjet printing layers, 40a and 40b, forming a part thereof are opaque printing layers containing pigments. The inkjet printing layers 40 (including the outermost layer) other than these are clear layers. The opaque inkjet printing layers 40a and 40b both represent, for example, the characters “ABC”, but the inkjet printing layers 40 as clear layers are interposed in between, and the opaque inkjet printing layers 40a and 40b are separated from each other in the printing thickness direction. According to this configuration, when the third thick printing portion 4C is viewed from an angle, the characters “ABC” can be further seen behind the characters “ABC”, which can give the characters a three-dimensional effect.

The third thick printing portion 4C may also be configured as shown in FIGS. 5A to 5D. In the configuration shown in the figures, one of two opaque inkjet printing layers 40c and 40d represents a part of the character “ABC”, and the other represents the remaining part of the character “ABC”. According to this configuration, since the characters are completed by combining the inkjet printing layers 40c and 40d, it is possible to give the characters a three-dimensional effect and adds fun.

The third thick printing portion 4C has been described as a specific example of displaying characters, but the invention is not limited thereto. The number and shape of the opaque inkjet printing layers similar to the above-mentioned inkjet printing layers 40a to 40d as described above may be variously changed to represent characters other than the above-mentioned characters and other desired designs so as to give a three-dimensional effect.

Next, an example of the method for manufacturing the above-mentioned cover body 3 will be described.

First, as shown in FIG. 6A, the flat plate-shaped color steel sheet 30 described with reference to FIG. 7 is prepared as a raw material for the cover body 3. The configuration of the color steel sheet 30 is as described above. Next, at a predetermined position on the color steel sheet 30 (strictly speaking, on the paint layer 30b of the color steel sheet 30), by repeatedly performing inkjet printing a plurality of times, as shown in FIG. 6B, the first to third thick printing portions 4A to 4C are provided.

Inkjet printing is performed using, for example, an inkjet printer 8 as shown in FIG. 8A. In the inkjet printer 8, a print head 80 is movable in the x and y directions orthogonal to each other on the upper side of a mounting table 81 on which the color steel sheet 30 is mounted and supported. As shown in FIG. 8B, the print head 80 includes a plurality of inkjet nozzles 82 for making inkjet paint of a predetermined color into droplets and sprayed the same onto the color steel sheet 30, and a pair of ultraviolet light sources 83 (83a, 83b).

For example, when performing inkjet printing while moving the print head 80 in an x1 direction of FIG. 8B as the main scanning direction, the ultraviolet light source 83a on the rear side in the main scanning direction is made to emit light, and the area immediately after inkjet printing is irradiated with ultraviolet light. Since the inkjet printing layer 40 contains an ultraviolet curable resin, the inkjet printing layer 40 can be rapidly cured (cured to the extent that bleeding does not occur) by irradiation with the ultraviolet light described above. When such a curing process is completed, the inkjet printing is performed again, and the inkjet printing and the curing process are repeated to form (overlay) the plurality of inkjet printing layers 40 in a laminated manner. When the inkjet printing is carried out in a direction opposite to the xl direction described above, the same effect as described above can be obtained by making the ultraviolet light source 83b to emit light instead of the ultraviolet light source 83a.

After finishing the above-mentioned inkjet printing on the color steel sheet 30, as shown in FIG. 6C, the color steel sheet 30 is heated to dry the first to the third thick printing portions 4A to 4C, and the thermosetting resin contained therin is cured. As a result, it is possible to increase the strength of the first to the third thick printing portions 4A to 4C, and make them have durability against the press-working performed thereafter.

After the thermosetting treatment described above, drawing as a press-working is performed on the color steel sheet 30 to form the outer peripheral flange portion 32 and the bulging portion 33 as shown in FIG. 6D. Along with this, press-working for forming the air supply port 34, the exhaust port 35 and the like; and trimming processing for removing the excess portion of the outer peripheral flange portion 32 and the like are performed.

The cover body 3 described above can be appropriately manufactured by a series of operating steps as described above. The operation of forming exhaust port 35 is performed by using a punch 7a and a die 7b, for example, as shown in FIG, the first thick printing portion 4A is provided so as to avoid the place where the exhaust port 35 is planned to be formed, and is provided with a non-printing portion having a width Lb larger than the width La of the punch 7a. Therefore, there is no possibility that the first thick printing portion 4A will be damaged by the contact with the punch 7a. This is the same for the second thick printing portion 4B.

In the cover body 3 described above, the surrouding of the exhaust port 35 may be heated by the exhaust gas and become hot. Therefore, of the paint layer 30b of the color steel sheet 30 constituting the cover body 3, the surrouding portion of the exhaust port 35 is inherently liable to deteriorate. Further, since the surrouding of the air supply port 34 is also subject to drippings, the surrouding portion of the air supply port 34 of the paint layer 30b is inherently liable to deteriorate.

Regarding this, since the first and the second thick printing portions 4A and 4B are respectively provided around the exhaust port 35 and the air supply port 34, the paint layer 30b is protected, and the above-mentioned risk is appropriately eliminated. Meanwhile, the first and the second thick printing portions 4A and 4B are large in thickness and durable, and are less likely to be damaged as compared with the paint layer 30b, thus the durability is improved. Further, since the plurality of inkjet printing layers 40 constituting the first and the second thick printing portions 4A and 4B are all clear layers containing no pigments, the occurrence of chalking is appropriately prevented.

Further, as described with reference to FIGS. 4A to 4D and FIGS. 5A to 5D, since the third thick printing portion 4C can represent three-dimensional characters, it is useful for enhancing the aesthetic properties or decoration of the hot-water unit U. Since the outermost layer of the inkjet printing layers 40 of the third thick printing portion 4C is a clear layer, the occurrence of chalking in the third thick printing portion 4C can also be appropriately prevented. In other words, since the clear layer does not contain pigments and does not cause chalking, if the clear layer is provided on the outermost layer of the third thick printing portion 4C, the occurrence of chalking in the third thick printing portion 4C due to aging can be appropriately prevented.

As can be understood from the above-described embodiment, since the thick printing portion in the invention is formed by laminating a plurality of inkjet printing layers on the location in an overlaid state, the thickness can be increased and high strength can be obtained. Therefore, representations that are difficult to represent (for example, a three-dimensional representation) can be enabled with only a single-layer inkjet printing layer. Moreover, the thick printing portion can be a printing layer that is less susceptible to damage than a single-layer inkjet printing layer, and can be less likely to deteriorate over time. When forming the thick printing portion, the curing process is performed each time the inkjet printing layer is formed by inkjet printing, therefore a thick thick printing portion can be formed appropriately.

FIGS. 10 to 12B show other embodiments of the invention. In these figures, the same or similar elements as those in the above-mentioned embodiment are designated by the same reference numerals as those in the above-mentioned embodiment, and redundant descriptions will be omitted.

In a cover body 3A shown in FIG. 10, a plurality of opaque inkjet printing layers 6 (corresponding to an example of the inkjet printing layer for design in the invention) representing, for example, a penguins design are provided on the front surface portion (on the paint layer 30b) of the cover body 3A. The white portion of the cover body 3A in FIG. 10 is a portion of the paint layer 30b of the color steel sheet 30 that has not been subjected to injet printing.

When forming the cover body 3A, the inkjet printing layers 6 are formed on the paint layer 30b of the color steel sheet 30, which is cured by ultraviolet light irradiation, and then the first to the third thick printing portions 4A to 4C are proviced. Therefore, the first to the third thick printing portions 4A to 4C are provided in a state of being overlapped on the inkjet printing layers 6 to protect the inkjet printing layers 6.

As a specific example, as shown in FIG. 11, the inkjet printing layers 6 representing a design is provided around the exhaust port 35. Next, the first thick printing portion 4A is further overlapped on the inkjet printing layers 6. Such a step is the same when the second and the third thick printing portions 4B and 4C are provided.

According to the present embodiment, since the design can be represented by the plurality of inkjet printing layers 6, the aesthetic properties can be improved as compared with the cover body 3 described above. The plurality of inkjet printing layers 6 (inkjet printing layers for design referred to in the invention) can represent not only the designs as described above, but also a variety of other characters, symbols, figures, or patterns.

A hot-water unit Ua shown in FIG. 12A is an indoor installation type, and a cover body 3B is provided with an air supply port 34a to which a filter 34b is attached and an operation panel portion 36. The exhaust port 35a is provided on the upper part of a case body 2a.

The operation panel portion 36 is configured as a device separate from the color steel sheet 30 constituting the main body portion of the cover body 3B, and is assembled to the main body portion as a part of the cover body 3B. The operation panel portion 36 is further provided with a plurality of thick printing portions 4D in addition to operation switches 36a for performing various settings such as hot water temperature, and a display portion 36b composed of a liquid crystal display or a 7-segment display for displaying a screen such as hot water temperature.

The plurality of thick printing portions 4D are provided in a form of a plurality of dots separated from each other to constitute Braille. More specifically, as shown in FIG. 12B, each thick printing portion 4D is a columnar small protrusion having the plurality of inkjet printing layers 40 laminated and, for example, having a height of about 0.3 to 0.5 mm and a diameter of about 1.4 mm. The plurality of inkjet printing layers 40 of each thick printing portion 4D are opaque inkjet printing layers containing pigments, and the colors thereof are, for example, the same as those of the front surface portion of the operation panel portion 36. However, preferably, the outermost layer of the inkjet printing layers 40 is a clear layer to prevent chalking. Of course the plurality of inkjet printing layers 40 may all be clear layers. The plurality of thick printing portions 4D correspond to Braille displaying desired items such as “contact information when a problem occurs in the hot-water unit Ua” or “notes regarding the hot-water unit Ua”.

The plurality of thick printing portions 4D described above are, for example, can be can be provided by performing inkjet printing to the operation panel portion 36 (a process of repeating the formation of the inkjet printing layers 40 and the curing process thereof at the same location) at a stage before the operation panel portion 36 is assembled as a part of the cover body 3B. However, the invention is not limited thereto, and the thick printing portions 4D may be provided after the operation panel portion 36 is assembled as a part of the cover body 3B.

Since the plurality of thick printing portions 4D described above display desired items in Braille, they can be made user-friendly. As another means for providing Braille, for example, a plate provided with Braille may be attached to the exterior case C, but this may cause the plate to peel off and fall off. On the other hand, according to the present embodiment, it is possible to eliminate such a risk. In addition, unlike the present embodiment, the thick printing portion similar to the thick printing portions 4D may be provided in other parts of the cover body 3B or in the case body 2a instead of the operation panel portion 36.

The invention is not limited to the contents of the above-described embodiments. The specific configuration of each step of the method for manufacturing the exterior case for the hot-water unit according to the invention can be variously redesigned within the scope of the invention.

In the above-described embodiment, for example, the first to third thick printing portions 4A to 4C show an example provided on the paint layer 30b on the surface side of the cover body 3, but the invention is not limited thereto. The thick printing portion referred to in the invention may be provided on the paint layer 30c on the back surface side of the cover body 3, or may be provided on the case body 2.

The thick printing portion referred to in the invention is a portion where a plurality of inkjet printing layers are laminated in an overlaid state, but the specific number, size, presence/absence of pigment (whether or not a clear layer), and the like of the plurality of inkjet printing layers constituting the thick printing portion are not limited. In order to prevent chalking, it is preferable that at least the outermost layer of the inkjet printing layers is a clear layer, but not limited thereto. When an inkjet printing layer different from the thick printing portion (for example, the inkjet printing layer 6 in FIG. 10) is provided, it does not matter whether the thick printing portion is laminated on the upper side of such an inkjet printing layer.

The specific position where the thick printing portion referred to in the invention is provided is also not limited. For example, it can be provided around the screw fastening place of the exterior case. If rust occurs on the screw around the screw fastening place, drippings containing the rust may contaminate the area around the screw fastening place and cause damage.

In order to suppress such a situation, the thick printing portion may be provided around the screwed portion.

The hot-water unit referred to in the invention may also be configured as a hot water storage tank unit or the like in which hot-water equipment for storing hot water such as a hot water storage tank is housed in an exterior case, instead of having hot-water equipment such as a water heater housed in an exterior case. Therefore, the exterior case is not limited to a combination of a case body having an opening portion on the front surface and a cover body that closes the front opening portion. A metal plate is generally used as the material of the exterior case, but a metal plate different from the commercially available color steel sheet may be used.

To the claims:

1. A method for manufacturing an exterior case for a hot-water unit, used to house hot-water equipment for generating or storing hot water inside, the method comprising:
a step combining an inkjet printing step for forming an inkjet printing layer by applying inkjet printing to an outer surface of a component of the exterior case; and a curing step for curing the inkjet printing layer, wherein the inkjet printing step and the curing step are repeated a plurality of times at a same location to form a thick printing portion in which a plurality of inkjet printing layers are laminated in an overlaid state.

2. The method for manufacturing an exterior case for a hot-water unit according to claim 1,
wherein the exterior case comprising an exterior case body having an opening portion on at least one surface, and a cover body attached to the exterior case body so as to close the opening portion, and
the thick printing portion on an outer surface of at least one of the exterior case body and the cover body is formed.

3. The method for manufacturing an exterior case for a hot-water unit according to claim 1,
wherein an ink containing an ultraviolet curable resin is used in the inkjet printing step, and ultraviolet light irradiation is performed in the curing step of the inkjet printing layer.

4. The method for manufacturing an exterior case for a hot-water unit according to claim 3,
wherein an ink further containing a thermosetting resin is used in the inkjet printing step, and the inkjet printing layer is heated and thermally cured after the curing step of the inkjet printing layer by ultraviolet light is completed.

5. The method for manufacturing an exterior case for a hot-water unit according to claim 1,
wherein an outermost layer of the inkjet printing layers of the thick printing portion is a clear layer.

6. The method for manufacturing an exterior case for a hot-water unit according to claim 1,
wherein the exterior case has at least one of an exhaust port and an air supply port, and
the method comprises a step for forming a thick printing portion provided around the exhaust port or the air supply port as the thick printing portion.

7. The method for manufacturing an exterior case for a hot-water unit according to claim 1, comprising:
a step for forming a thick printing portion comprising a plurality of opaque inkjet printing layers containing pigments, and inkjet printing layer as clear layers located in between so as to separate the plurality of inkjet printing layers from each other in a printing thickness direction as the thick printing portion.

8. The method for manufacturing an exterior case for a hot-water unit according to claim 1, further comprising:
a step for providing an inkjet printing layer for design representing at least one of characters, symbols, figures, or patterns on the outer surface of the components of the exterior case.

9. The method for manufacturing an exterior case for a hot-water unit according to claim 1, comprising:
a step for forming a plurality of thick printing portions in a form of a plurality of dots separated from each other and constituting Braille as the thick printing portion.
